(19) United States
(12) Patent Application Publication
(10) Pub. No.: US 2025/0217177 A1
(43) Pub. Date: Jul. 3, 2025

(54) SYSTEM AND METHOD FOR CORRELATING VIRTUAL MACHINE INTERRUPTIONS AND NODE CHARACTERISTICS

(71) Applicant: Microsoft Technology Licensing, LLC, Redmond, WA (US)

(72) Inventors: Chin Hwan Park, Bellevue, WA (US); Adam Marc Gustafson, Seattle, WA (US); William Harris, Mountlake Terrace, WA (US); Ramakoti R. Bhimanadhuni, Bothell, WA (US); Jessica Dean Sierra, Seattle, WA (US); Li-Fan Ko, Bellevue, WA (US); Nicholas Anthony Swanson, Woodinville, WA (US); Lingling Zheng, Redmond, WA (US); Cristopher Benge, Berryville, VA (US); Siduo Jiang, San Antonio, TX (US); Yash Jayesh Dagli, Redmond, WA (US); Kehinde Ajayi, Norfolk, VA (US); Maryam Nikouei Mehr, Bothell, WA (US); Meng Jin, Sammamish, WA (US)

(21) Appl. No.: 18/398,873

(22) Filed: Dec. 28, 2023

(51) Int. Cl. G06F 9/455

(52) U.S. Cl. CPC G06F 9/45558; G06F 2009/45575; G06F 2009/45591

(57) ABSTRACT

A method, computer program product, and computing system for collecting data concerning interruptions associated with a plurality of virtual machines, and for collecting hardware information concerning one or more nodes hosting the plurality of virtual machines at a time generally contemporaneous with the interruptions of the plurality of virtual machines. A correlation is generated between interruptions of at least a subset of the plurality of virtual machines and one or more hardware component attributes of the one or more nodes.

### BACKGROUND

In cloud computing environments it is desirable to maximize virtual machine availability. Often virtual machine availability may be quantified in terms of virtual machine interruption rates. In general, virtual machine interruption rates may provide a measure of virtual machines interruption relative to total up-time. However, such metrics often fail to account for situations in which the failure of a single node may result in multiple virtual machine failures. As such, virtual machine interruptions may often be clustered due to a single node reboot event. Further, virtual machine interruption rates alone may not provide a great deal of insight into the root causes of any interruptions, or how interruption rates may be decreased.

### BRIEF DESCRIPTION OF THE DRAWINGS

FIG. 1 is a flow chart of one implementation of a correlation process;

FIG. 2 is a diagrammatic view of an example cloud computing environment that may implement the correlation process of FIG. 1;

FIG. 3 is a diagrammatic view of example nodes implemented in the cloud computing environment of FIG. 2;

FIG. 4 is a diagrammatic view of a node, according to an example embodiment;

FIG. 5 is a diagrammatic view of computer system and the correlation process coupled to a distributed computing network.

Like reference symbols in the various drawings indicate like elements.

### DETAILED DESCRIPTION OF THE EMBODIMENTS

Implementations of the present disclosure determine correlations between virtual machine interruptions and hardware characteristics of nodes hosting the virtual machines. For example, in a cloud computing environment, a node may host one or more virtual machines. Often, for example in a large scale computing environment, multiple nodes (e.g., computing servers) may each host one, or more than one, virtual machine. From time to time, virtual machines may experience interruptions, ranging from minor degradation in performance to complete failure of the virtual machine. Such interruptions can result from a variety of root causes, for example, underlying software problems associated with the virtual machine, execution errors in operations being carried out on the virtual machine, hardware failures of node, and the like. In many instances, interruptions may result from only a software problem, or from a hardware problem. However, implementations of the present disclosure may determine correlations between virtual machine interruptions and hardware characteristics of the node hosting the virtual machine indicating a particular sensitivity of a specific virtual machine to the underlying hardware components and/or hardware configuration of the node hosting the virtual machine.

As will be appreciated, various virtual machines may have different configurations (e.g., different operating systems and/or versions, different computing requirements, different storage requirements, execute different software, and the like). Similarly, different nodes may also have various hardware configurations (e.g., CPUs, RAM, hard disks or solid disk drives, network interface cards, GPUs, and the like). Virtual machines may be paired with (i.e., hosted on) nodes having a hardware configuration that well suited for the intended use of the virtual machine. For example, a general purpose virtual machine may be hosted on a node providing a combination of vCPUs, memory, and temporary storage able to meet the requirements associated with most production workloads, whereas a virtual machine optimized for heavy in-memory applications may be hosted on a node offering high memory-to-core ratios, which makes them well-suited for memory-intensive enterprise applications. While virtual machines may be hosted on nodes having hardware configurations appropriate for the intended purpose of the virtual machine, it has often been assumed that virtual machine interruption rates are independent of the hardware configuration and/or hardware components of the node hosting the virtual machine. As described below in greater detail, implementations of the present disclosure may provide interruption rate correlations between virtual machine configurations and hardware node configurations. As such, consistent with some implementations, certain virtual machine configurations hosted on certain node configurations may be correlated with increased node interruption rates and/or with increased interruption rates for certain virtual machine configurations hosted on certain node configurations. In some implementations, sensitivity of certain virtual machines configuration may be correlated with certain node configurations, e.g., as resulting in an increased interruption rate. Further, in some implementations, the correlations of increased interruption rates may be made between certain virtual machine configurations and specific hardware component attributes.

As will be discussed in greater detail below, implementations of the present disclosure gather and analyze information concerning both a virtual machine experiencing an interruption, and the underlying hardware (i.e., the node) hosting interrupted virtual machines. For example, the information concerning the virtual machine experiencing the interruption can include the configuration of the virtual machine and the performance of the virtual machine at the time of the interruptions, as well as additional information. Information concerning the underlying hardware hosting the interrupted virtual machine can include hardware performance, such as any errors or problems occurring in any of the hardware components of the node, as well as characteristics of the different hardware components of the node. Information concerning hardware errors and hardware components can be considered down to an extremely granular level, such as which component of the node experienced an error, and what are the make, model, generation, etc., of the various hardware components of the node. By considering virtual machine interruptions along with the hardware performance and/or hardware component information of the node hosting the interrupted virtual machine relationships can be observed between virtual machine configurations and node errors and/or specific hardware components. Conventional approaches only consider the number of interruptions and/or the downtime of virtual machines compared to uptime of the virtual machines, or even simply identify a number of interruptions in a given time window. Such approaches may provide an indication of a degree of availability of the virtual machines, it does not provide any actionable information regarding the causes of the virtual machine interruptions, or opportunities to mitigate virtual machine interruptions.

The details of one or more implementations are set forth in the accompanying drawings and the description below. Other features and advantages will become apparent from the description, the drawings, and the claims.

### The Correlation Process:

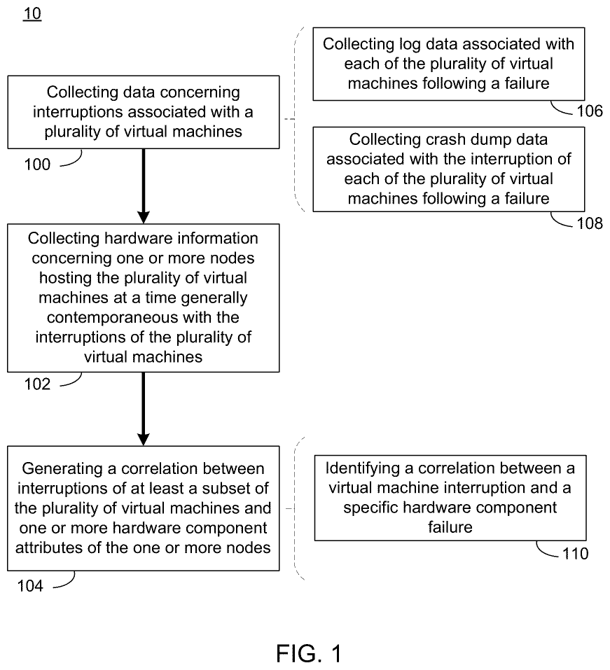

Referring to FIGS. 1-4, correlation process 10 collects 100 data concerning interruptions associated with a plurality of virtual machines. Hardware information concerning one or more nodes hosting the plurality of virtual machines is collected 102 at a time generally contemporaneous with the interruptions of the plurality of virtual machines. Correlation process 10 further generates 104 a correlation between interruptions of at least a subset of the plurality of virtual machines and one or more hardware component attributes of the one or more nodes.

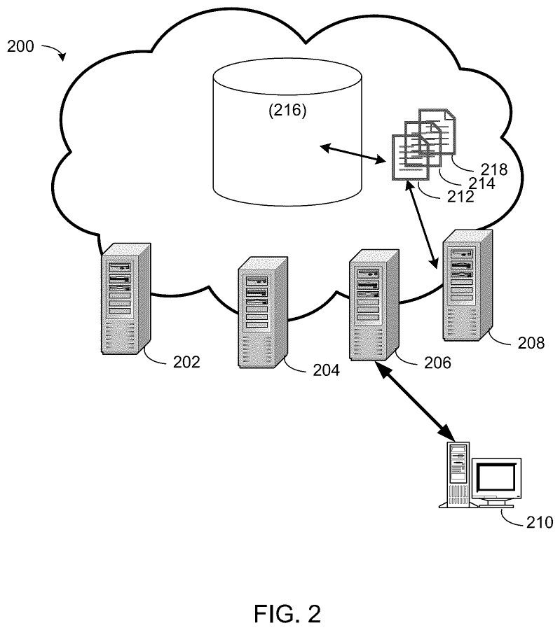

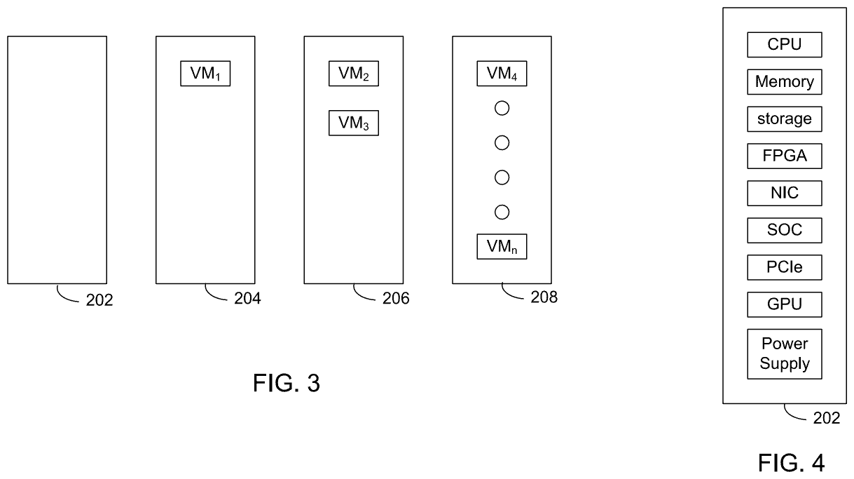

In some implementations, correlation process 10 collects 100 data concerning interruptions associated with a plurality of virtual machines. Referring also to FIG. 2, a cloud computing environment 200 provides cloud computing resources to various clients. For example, cloud computing environment 200 may include one or more nodes (e.g., nodes 202, 204, 206, 208) that may each potentially host one or more virtual machines. Each of the nodes 202, 204, 206, 208 including computing devices (such as server computing devices) that may have various hardware configuration to enable the nodes to host respective virtual machines. As discussed, and referring also to FIG. 3, each of the nodes may potentially host one or more virtual machines. For example, at a given point in time, node 202 may not be hosting any virtual machines (i.e., node 202 may be an empty node). Further, at a given point in time, various nodes may host one or more virtual machines (e.g., node 204 may host a single virtual machine, VM₁, node 206 may host two virtual machines, VM₂, VM₃, and node 208 may host a plurality of virtual machines, VM₄-VMₙ). One or more of the virtual machines may be accessed by, or the cloud computing resources of the virtual machine may be made available to, a client computing device 210.

The virtual machines hosted by the various nodes may have similar and/or differing configurations. For example, different virtual machines may implement various operating systems, execute various applications, and the like. Similarly, different virtual machines may have different CPU utilization, memory allocation, CPU-to-memory ratio, temporary storage, local drive storage (e.g., hard drive or solid state drive storage), and the like. Example configurations may include general purpose compute virtual machines having a combination of CPU allocation, memory and temporary storage appropriate for many production workloads. Virtual machines optimized for in-memory applications may be configured with high memory-to-core ratios appropriate for many memory-intensive applications, large relational database servers, in-memory analytics workloads, and the like. Compute optimized virtual machines may be configured with a higher CPU-to-memory ratio, and may be equipped with RAM and solid state drive per CPU core ratios appropriate for compute intensive workloads. Memory and storage optimized virtual machines may have high CPU core and RAM allocations and relatively large solid state drive storage available that may be appropriate for very demanding applications. Storage optimized virtual machines may support relatively high local solid state drive storage appropriate for applications requiring low latency, high throughput, and large local disk storage. Memory optimized virtual machines may be configured with relatively high virtual CPU count and relatively large available RAM appropriate for heavy in-memory workloads. Additional virtual machines may be configured with GPU capabilities (e.g., general-purpose graphics processing units, or GPGPU) for graphics-intensive workloads. Various additional and/or alternative virtual machine configurations may be provided as well. Further, in some implementations, virtual machine configurations may be generally grouped into families, i.e., virtual machines have the same or similar configurations.

As discussed above, in the event of an interruption associated with one or more virtual machines, correlation process 10 collects 100 data concerning the interruptions associated with the plurality of virtual machines. In some implementations, interruption of a virtual machine may include a total failure of the virtual machine resulting in a reboot of the virtual machine. In some implementations, interruption of a virtual machine may include a temporary or ongoing diminished performance of the virtual machine. Interruption of a virtual machine may be caused by a software problem of the virtual machine itself (e.g., the virtual machine operating system or error of an application executed by the virtual machine) or a problem associated with node hosting the virtual machine (e.g., an error associated with one or more hardware components of the node, a reboot of the node, etc.).

In some implementations, interruptions associated with a plurality of virtual machines may include a single interruption event, and/or may include multiple interruption events. For example, continuing with the previously discussed cloud computing environment, node 208 may host a plurality of virtual machines, VM₄-VMₙ. In the event of an interruption associated with node 208 (e.g., a reboot of node 208), each of the plurality of virtual machines hosted by node 208 may experience an interruption. Similar, interruptions (e.g., diminished performance or availability of one or more of VM₄-VMₙ) may occur if a hardware fault or failure associated with node 208 occurs. Further, in some implementations, interruptions associated with a plurality of virtual machines may include different interruption events occurring on different nodes (e.g., interruption of VM₁ hosted on node 204, interruption of VM₂ and VM₃ on node 206, etc.). The different interruption events may occur at different times, and may be unrelated interruption events. Similarly, in some implementations interruptions associated with a plurality of virtual machines may include interruptions associated with the same virtual machine, a common group of virtual machines, and/or virtual machines hosted on the same node, in which the interruptions occur at different times. For example, the interruption of a plurality of virtual machines may include an interruption of VM₁ occurring at time 1 and an interruption of VM₁ occurring at time 2, which may be different from time 1 (including being separated by hours, days, weeks, etc., from time 1). Similarly, in some implementations, interruptions associated with a plurality of virtual machines may include interruptions associated with virtual machines hosted on different nodes. For example, an interruption may be associated with VM₁ hosted on node 204, and associated with one or more of VM₂ and VM₃ hosted on node 206, and/or associated with one or more of VM₄-VMₙ hosted on node 208. Consistent with such an example, the various interruptions of virtual machines hosted on different nodes may occur at a generally similar time and/or may occur at differing times (including hours, days, weeks, etc., apart). Accordingly, in some implementations the collected 100 data concerning interruptions associated with a plurality of virtual machines may include historical virtual machine interruption data.

In some implementations, collecting 100 data concerning interruptions associated with a plurality of virtual machines may include collecting 106 log data (e.g., log data 212) associated with each of the plurality of virtual machines (e.g., one or more of VM₄-VMₙ hosted on node 208) following a failure (e.g., an interruption, partial failure, and/or complete failure) of each respective virtual machine. While log data 212 is depicted as associated with one or more of VM₄-VMₙ hosted on node 208, as discussed above, interruptions associated with a plurality of virtual machines may include other situations and/or interruption events, including interruptions occurring at different times, occurring on different nodes, and the like. In some implementations, collecting 106 log data associated with each of the plurality of virtual machines following a failure of each respective virtual machine may include obtaining log data for each respective virtual machine that was routinely generated during the operation of each of the virtual machines. For example, as is known, during operation of a virtual machine various log information may be generated and stored (e.g., in log storage 216, locally on node 208 hosting the virtual machines, or otherwise stored) concerning the configuration, operation, performance, etc., of each virtual machine. In some such implementations, collecting 106 log data associated with each of the plurality of virtual machines following a failure of each respective virtual machine may include accessing and/or collecting the log data 212 from log storage 216. In some implementations, the log data 212 may include log data from immediately before (including up to) the interruption of the plurality of virtual machines, and/or may include log data from any time between the instantiation of each virtual machine and the interruption of each virtual machine. The collected 106 log data may include, in part, an identification and/or attributes of node 208 hosting virtual machines VM₄-VMₙ.

In some implementations, collecting 100 data concerning interruptions associated with a plurality of virtual machines may include collecting 108 crash dump data 214 associated with the interruption of each of the plurality of virtual machines following a failure of each respective virtual machine. As is generally known, a crash dump may include one or more files that may be created to capture information about the state of an operating system in the event of a system crash. According to various implementations, system configurations, and/or system preferences, crash dump data 214 may include, but is not limited to, the content (in some situations the entire contents) of the physical memory at the time of the crash (e.g., interruption of the virtual machine), data concerning parameters, lists of loaded device drivers, information about the current process(es) and/or thread(s), kernel stack, etc. The crash dump data 214 may be generated and/or stored at the time of the interruption of a virtual machine, and/or may be created at the time of/relate to a failure associated with the node hosting the virtual machine (e.g., node 208 hosting virtual machines VM₄-VMₙ). The crash dump data 214 may be stored on a suitable storage device, e.g., in log storage 216, locally on node 208 hosting the virtual machines, or otherwise stored.

As discussed above, collecting 100 data concerning interruptions associated with a plurality of virtual machines may include collecting 106 log data 212, which may include one or more of configuration, operation, and performance of each respective virtual machine. Collecting 100 data concerning interruptions associated with a plurality of virtual machines may include collecting 108 crash dump data 214 associated with the interruptions of each virtual machine. In some implementations, collecting 100 data concerning interruptions associated with a plurality of virtual machines may include collecting data concerning one or more of each respective virtual machine type, each virtual machine size, each virtual machine configuration, each virtual machine family (e.g., as generally discussed above), a node hosting each virtual machine, and the like.

In some implementations, correlation process 10 collects 102 hardware information (e.g., hardware information 218) concerning one or more nodes hosting the plurality of virtual machines at a time generally contemporaneous with the interruptions of the plurality of virtual machines. For example, collecting information concerning one or more nodes hosting the plurality of virtual machines may include collecting hardware information may include collecting hardware information in response to an interruption of one or more of the virtual machines. In such an example, when an interruption (e.g., a reboot and/or other determined diminished performance or availability) is detected with respect to a virtual machine, hardware information is collected concerning a node hosting the interrupted virtual machine. As discussed above, interruption of the plurality of virtual machines may include an interruption of multiple virtual machines hosted by a single node, with the interruption of the plurality of virtual machines occurring in a same general time period. Further, in some implementations, interruption of the plurality of virtual machines may occur as an interruption of different virtual machines, and/or groups of virtual machines, at different time periods (e.g., interruptions occurring in relatively short timewise succession, and/or interruptions occurring over a greater timeframe, including hours, days, weeks, etc., apart). In still further implementations, interruption of the plurality of virtual machines may occur on different nodes, at a similar time and/or at different times. In each example, at each interruption of a respective virtual machine, hardware information concerning the node, or respective nodes, associated with the interrupted virtual machine may be collected 102.

In some implementations, the hardware information concerning the one or more nodes may be collected 102 in response to an interruption associated with a node hosting a virtual machine. The interruption associated with the node may include a complete failure of the node (e.g., a reboot of the node) and/or a temporary or ongoing diminished performance of the node. In an example, an interruption associated with a node may be inferred from an interruption associated with one or more virtual machines hosted by a node. For example, if one, some, or all of the virtual machines hosted by a node experience an interruptions, particular at the same time and/or within a relatively short time period, an interruption of the node may be inferred. In a particular example, if virtual machines VM₄-VMₙ each experience an interruption (e.g., which may be experienced as a loss or decrease in availability of virtual machines VM₄-VMₙ) at the same time, and/or within a relatively short period of time, and interruption (e.g., failure and/or reboot) of node 208 may be inferred. In this regard, interruptions of multiple virtual machines hosted on the same node may tend to be highly correlated. In some implementations, an interruption of the node may be directly detected, e.g., as a reboot of the node and/or as another detected failure or diminished performance of the node.

In some implementations, collecting 102 hardware information concerning the one or more nodes hosting virtual machines may include collecting an ID of the node hosting the one or more interrupted virtual machines. Similarly, an identification of the type (e.g., configuration, family, etc.) of virtual machine being hosted by the node may be identified when a node interruption or failure is detected. In some implementations the hardware information collected concerning the one or more nodes hosting the plurality of virtual machines, and/or one or more of the plurality of virtual machines, may include an indication of a failure of at least one hardware component. Further, in some implementations, the hardware information collected 102 may include a state of at least one hardware component of the node.

For example, and referring also to FIG. 4, a node (e.g., node 202) may include a computing device, such as a server computer. As is generally known, node 202 may include a number of hardware component, including, but not limited to, a processor (e.g., CPU), a memory (e.g., RAM, ROM, flash memory, etc.), a storage device (hard disk drive, solid state disk drive, etc.), a field programmable gate array (FPGA), a network interface card (NIC), a system-on-chip (SOC), a power supply, a PCIe component, and a graphics processor (e.g., GPU or GPGPU). Information concerning a failure, error, or state of one or more of the hardware components of the node may be collected 102. Such information may include, e.g., an indication of an error or failure, a performance statistic, a utilization statistic, and identification of one or more virtual machines utilizing the hardware component, and the like. In some implementations, in addition to failures and/or states of the hardware components, specific information concerning the identification of the hardware components may be collected 102. Examples of identification information of the hardware components may include manufacturer, model, a generation, a stock keeping unit (sku), and/or any other specific identifier of the hardware components. In some implementations, hardware information 218 may be directly collected 102, e.g., from node 208 in the illustrated example. In some implementations, hardware information 218 may be collected, e.g., from specifications related to node 208. In some embodiments, hardware information may be stored, e.g., in storage device 216, and other another storage device.

In some implementations, correlation process 10 generates 104 a correlation between interruptions of at least a subset of the plurality of virtual machines and one or more hardware component attributes of the one or more nodes. In some implementations, generating 104 a correlation between interruptions of at least a subset of the virtual machines and one or more hardware component attributes includes modelling attributes of interrupted virtual machines (e.g., virtual machine family, virtual machine configuration, virtual machine type, virtual machine size, etc.) and hardware component attributes to determine relationships. Such modelling may, for example, indicate if a particular virtual machine interruption (based on a virtual machine attribute) may be a software issue with the virtual machine itself, or if there is a relationship between interruptions of virtual machines with a particular attribute hosted on nodes having particular hardware component attributes. Accordingly, generating 104 a correlation between interruptions of at least a subset of the plurality of virtual machines and one or more hardware component attributes may include, for a node interruption, examining the virtual machines being hosted by the node at the time of the interruption (such as a node reboot, etc.). For example, various node interruptions may be correlated with specific virtual machine types or configurations being hosted by the node, and or specific mixes of different virtual machine types or configurations being hosted by the node. Such modelling may be achieved through the collection data concerning interruptions of virtual machines and the collection of hardware information concerning a large number of virtual machine and/or node interruptions. Further, such modelling may consider hardware component specifics, e.g., down to the hardware component sku-level.

Consistent with some implementations, interruption rate (e.g., node-level interruption and/or virtual machine-level interruption) may be correlated with specific virtual machines, and/or combination of commonly hosted virtual machines (e.g., one or more virtual machine configuration A being hosted on the same node with one or more virtual machine configuration B), with hardware component attributes of nodes hosting the virtual machines and/or combinations of virtual machines. For example, it may be uncommon for a virtual machine configuration, or combination of virtual machine configurations commonly hosted, to regularly experience interruption of either a given virtual machine or given node. However, a correlation may be determined indicating an even modestly higher interruption rate for some virtual machine configuration-node combinations and/or combinations of virtual machine configurations-node combinations.

Consistent with some implementations, generating 104 a correlation between interruptions of at least a subset of the plurality of virtual machines and one or more hardware component attributes includes identifying 110 a correlation between a virtual machine interruption and a specific hardware component failure. A hardware component failure may include a complete failure of a hardware component and/or specific performance or operation state of the hardware component. For example, the collected 102 hardware information may be analyzed to determine if a hardware error occurred prior to, and/or at the time, of the node interruption and/or of the virtual machine interruption. As such, a correlation may be determined that certain virtual machine configurations may be more sensitive to particular hardware failures, e.g., given that an identified hardware failure may cause a higher interruption rate for a specific virtual machine configuration but may not cause a higher interruption rate for one or more other virtual machine configurations. In some implementations, a correlation between a specific hardware component failure and an interruption of a specific virtual machine configuration may be determined based upon, at least in part, a higher interruption rate for a specific virtual machine configuration experience on one type of node (e.g., a node having a specific hardware configuration including hardware components of a given manufacturer, model, generation, sku, etc.) as compared to other types of nodes (e.g., nodes having different specific hardware configuration).

In some implementations, patterns of virtual machine interruptions can be statistically modeled in relation to various hardware component failures and/or hardware configuration (e.g., manufacture, model, generation, sku of hardware components of a node). Such statistical analysis may indicate that for a given hardware configuration, certain virtual machine configurations may experience a higher interruption rate. This statistical analysis can be conducted across a plurality of virtual machine configurations and a plurality of nodes. In some implementations, statistical modeling may relax the assumption that different nodes are independent of each other, e.g., for hardware nodes of the same and/or overlapping hardware configurations (e.g., common hardware component manufacturer, model, generation, sku, etc.). Such modelling may provide an indication of why, for a given note, some virtual machine configurations may fail together, while other virtual machines hosted on the same node may operate acceptably (e.g., are not as sensitive to particular hardware failures).

Consistent with the foregoing, the collected 102 hardware information may be analyzed to identify hardware components that are most likely to be involved in the interruption based on available telemetry data at the time of the interruption. In some implementations, a category of hardware failure that occurred at the time of the interruption may be correlated with a specific virtual machine configuration. For example, certain virtual machine interruptions may coincide with certain hardware failures at a relatively higher rate than other hardware failures. For example, memory optimized virtual machines may experience a higher rate of RAM failures as compared to, for example, general purpose virtual machine configurations. As discussed above, other hardware failures may include, but are not limited to, e.g., CPU failures, memory failures, solid state disc failures, power infrastructure failures, and the like. These various hardware failures may be correlated with higher interruption rates of specific virtual machine configurations, and more particularly, in some implementations particular hardware component attributes (e.g., manufacturer, model, generation, sku, etc.) of the failed hardware component may be correlated with higher rates of interruption for specific virtual machine configurations.

Continuing with the foregoing, in some implementations, node interruption rate may be correlated with hardware node failure symptoms (e.g., hardware component attributes, performance, etc.) and virtual machine configurations of the virtual machines hosted by the node at the time of the interruption. The node interruption rate may be compared with details of the interrupted virtual machine(s) to generate a correlation between hardware configuration and performance and virtual machine behavior. This correlation may additionally provide an understanding of whether specific virtual machine configurations may accelerate hardware node interruption at greater rate as compared to other virtual machine configurations.

As discussed above, in some implementations, interruption of a node (e.g., as a result of a reboot event) may be inferred from virtual machine availability data of the virtual machines hosted on the node. As such, an uncertainty in the event rate (i.e., interruption event rate) may be deduced using confidence intervals attained by assuming the events occur according to a homogeneous Poisson process. This homogeneity assumption in the Poisson process can be relaxed such that the event rate depends on covariates (node attributes, utilization, virtual machine density, etc.), and comparisons between groups can be done based upon regression modeling approaches for such data (e.g., Cox regression, piecewise constant hazard rate regression, etc.), which is feasible for hundreds of thousands of nodes in the analysis scope. Consistent with various additional and/or alternative implementations, correlations may be made, and/or predicted, using machine learning models.

Consistent with some implementations, correlations between virtual machine interruptions and hardware component attributes may allow hardware and/or virtual machine interruptions to be, at least in part, mitigated. For example, when a correlation between an elevated rate of virtual machine interruption and/or node interruption when hosting specific virtual machine configurations is determined, the allocation of virtual machine configurations (and/or combinations of different virtual machines commonly hosted) across available nodes may be controlled to mitigate interruptions. For example, if a correlation is determined indicating a higher interruption rate for certain virtual machine-node combinations, allocation of the certain virtual machines may be made to avoid node on which the combination may result in a higher interruption rate. In some implementations, if a virtual machine configuration-node combination has been made, hardware component attributes may be recognized correlated with a heightened interruption rate. Upon determining such a correlation, one or more virtual machines hosted by the node may be offloaded to a different node to mitigate the risk of an interruption. In some implementations, hosting rules and/or guidelines may be implemented to host certain virtual machine configurations on nodes having hardware components (e.g., hardware component sku's) correlated with relatively lower interruption rates. Still further, in some implementations, when a correlation between a relatively heightened interruption rate and a particular hardware components has been made, this information can be used to drive manufacturing of nodes utilizing hardware components not correlated with heightened interruption rates. Consistent with some implementations, overall cloud RAS (reliability/availability/serviceability) may be improved for faster and deeper failure analysis for complex software/hardware mixed problems and/or situations. For example, a determined correlation may improve failure root cause analysis as well as machine learning based hardware component failure prediction. In some implementations, upon determining such a correlation, one or more virtual machines hosted by a node may be offloaded to a different node to mitigate the risk of an interruption.

### System Overview:

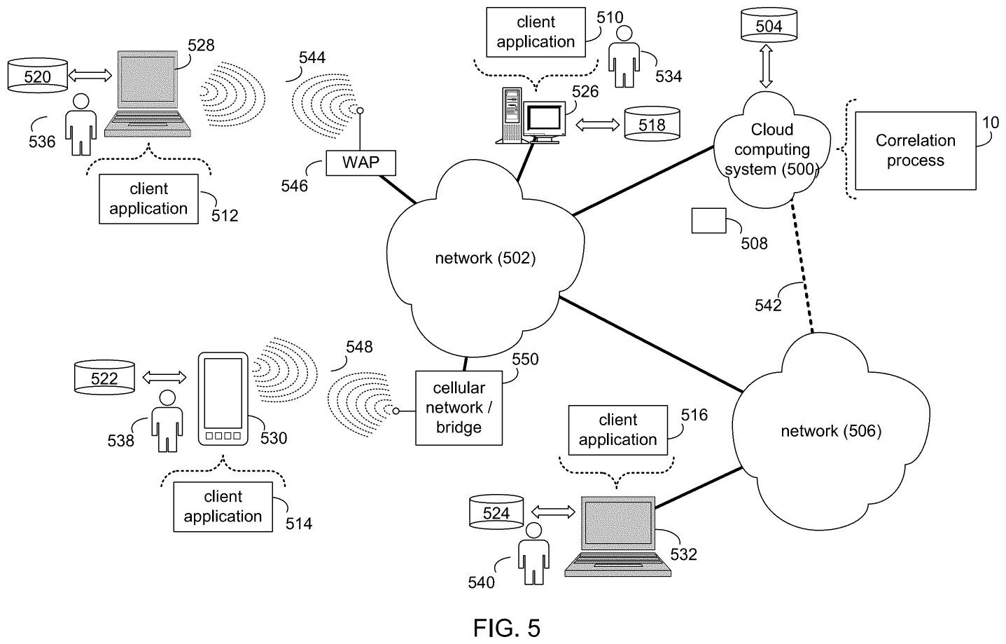

Referring to FIG. 5, a correlation process 10 is shown to reside on and is executed by cloud computing system 500, which is connected to network 502 (e.g., the Internet or a local area network). Examples of cloud computing system 500 include: a server array, a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of cloud computing system 500 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of cloud storage ownership process 10, which are stored on storage device 504 included within cloud computing system 500, are executed by one or more processors (not shown) and one or more memory architectures (not shown) included within cloud computing system 500. Storage device 504 may include: a hard disk drive; an optical drive; a RAID device; a random-access memory (RAM); a read-only memory (ROM); and all forms of flash memory storage devices. Additionally or alternatively, some portions of the instruction sets and subroutines of correlation process 10 are stored on storage devices (and/or executed by processors and memory architectures) that are external to cloud computing system 500.

In some implementations, network 502 is connected to one or more secondary networks (e.g., network 506), examples of which include: a local area network; a wide area network; or an intranet.

Various virtual machine and/or node data (e.g., data 508) are sent from client applications 510, 512, 514, 516 to cloud computing system 500.

The instruction sets and subroutines of client applications 510, 512, 514, 516, which may be stored on storage devices 518, 520, 522, 524 (respectively) coupled to client electronic devices 526, 528, 530, 532 (respectively), may be executed by one or more processors (not shown) and one or more memory architectures (not shown) incorporated into client electronic devices 526, 528, 530, 532 (respectively). Storage devices 518, 520, 522, 524 may include: hard disk drives; tape drives; optical drives; RAID devices; random access memories (RAM); read-only memories (ROM), and all forms of flash memory storage devices. Examples of client electronic devices 526, 528, 530, 532 include personal computer 526, laptop computer 528, smartphone 530, laptop computer 532, a server (not shown), a data-enabled, and a dedicated network device (not shown). Client electronic devices 526, 528, 530, 532 each execute an operating system.

Users 534, 536, 538, 540 may access cloud computing system 500 directly through network 502 or through secondary network 506. Further, cloud computing system 500 may be connected to network 502 through secondary network 506, as illustrated with link line 542.

The various client electronic devices may be directly or indirectly coupled to network 502 (or network 506). For example, personal computer 526 is shown directly coupled to network 502 via a hardwired network connection. Further, laptop computer 532 is shown directly coupled to network 506 via a hardwired network connection. Laptop computer 528 is shown wirelessly coupled to network 502 via wireless communication channel 544 established between laptop computer 528 and wireless access point (e.g., WAP) 546, which is shown directly coupled to network 502. WAP 546 may be, for example, an IEEE 802.11a, 802.11b, 802.11g, 802.11n, Wi-Fi®, and/or Bluetooth® device that is capable of establishing a wireless communication channel 544 between laptop computer 528 and WAP 546. Smartphone 530 is shown wirelessly coupled to network 502 via wireless communication channel 548 established between smartphone 530 and cellular network/bridge 550, which is shown directly coupled to network 502.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
collecting data concerning interruptions associated with a plurality of virtual machines;
collecting hardware information concerning one or more nodes hosting the plurality of virtual machines at a time generally contemporaneous with the interruptions of the plurality of virtual machines; and
generating a correlation between interruptions of at least a subset of the plurality of virtual machines and one or more hardware component attributes of the one or more nodes.

2. The computer-implemented method according to claim 1, wherein collecting data concerning interruptions associated with a plurality of virtual machines includes one or more of:
collecting log data associated with each of the plurality of virtual machines following a failure of each respective virtual machine; and
collecting crash dump data associated with the interruption of each of the plurality of virtual machines following a failure of each respective virtual machine.

3. The computer-implemented method according to claim 1, wherein the data concerning interruptions associated with the plurality of virtual machines includes one or more of:
virtual machine type;
virtual machine size; and
virtual machine configuration.

4. The computer-implemented method according to claim 1, wherein the hardware information concerning one or more nodes hosting the plurality of virtual machines includes one or more of:
an indication of a failure of at least one hardware component; and
a state of at least one hardware component.

5. The computer-implemented method according to claim 4, wherein the at least one hardware component includes one or more of a processor, a memory, a storage device, a field programmable gate array (FPGA), a network interface card (NIC), a system-on-chip (SOC), a power supply, a PCIe component, and a graphics processor.

6. The computer-implemented method according to claim 1, wherein the one or more hardware component attributes includes one or more of a manufacturer of a hardware component, a model of a hardware component, a generation of a hardware component, and a stock keeping unit (SKU) of a hardware component.

7. The computer-implemented method according to claim 2, wherein generating the correlation between interruptions of at least a subset of the plurality of virtual machines and one or more hardware component attributes includes identifying a correlation between a virtual machine interruption and a specific hardware component failure.

8. A computing system comprising:
a memory; and
a processor configured to collect data concerning interruptions associated with a plurality of virtual machines, collect hardware information concerning one or more nodes hosting the plurality of virtual machines at a time generally contemporaneous with the interruptions of the plurality of virtual machines, and to generate a correlation between interruptions of at least a subset of the plurality of virtual machines and one or more hardware component attributes of the one or more nodes.

9. The computing system according to claim 8, wherein the processor configured to collect data concerning interruptions associated with a plurality of virtual machines is configured to one or more of:
collect log data associated with each of the plurality of virtual machines following a failure of each respective virtual machine; and
collect crash dump data associated with the interruption of each of the plurality of virtual machines following a failure of each respective virtual machine.

10. The computing system according to claim 8, wherein the data concerning interruptions associated with the plurality of virtual machines includes one or more of:
virtual machine type;
virtual machine size; and
virtual machine configuration.

11. The computing system according to claim 8, wherein the hardware information concerning one or more nodes hosting the plurality of virtual machines includes one or more of:
an indication of a failure of at least one hardware component; and
a state of at least one hardware component.

12. The computing system according to claim 11, wherein the at least one hardware component includes one or more of a processor, a memory, a storage device, a field programmable gate array (FPGA), a network interface card (NIC), a system-on-chip (SOC), a power supply, a PCIe component, and a graphics processor.

13. The computing system according to claim 8, wherein the one or more hardware component attributes includes one or more of a manufacturer of a hardware component, a model of a hardware component, a generation of a hardware component, and a stock keeping unit (SKU) of a hardware component.

14. The computing system according to claim 9, wherein the processor configured to generate the correlation between interruptions of at least a subset of the plurality of virtual machines and one or more hardware component attributes is configured to identify a correlation between a virtual machine interruption and a specific hardware component failure.

15. A computer program product residing on a non-transitory computer readable medium having a plurality of instructions stored thereon which, when executed by a processor, cause the processor to perform operations comprising:
collecting data concerning interruptions associated with a plurality of virtual machines;
collecting hardware information concerning one or more nodes hosting the plurality of virtual machines at a time generally contemporaneous with the interruptions of the plurality of virtual machines; and
generating a correlation between interruptions of at least a subset of the plurality of virtual machines and one or more hardware component attributes of the one or more nodes.

16. The computer program product according to claim 15, wherein collecting data concerning interruptions associated with a plurality of virtual machines includes one or more of:
collecting log data associated with each of the plurality of virtual machines following a failure of each respective virtual machine; and
collecting crash dump data associated with the interruption of each of the plurality of virtual machines following a failure of each respective virtual machine.

17. The computer program product of according to claim 15, wherein the data concerning interruptions associated with the plurality of virtual machines includes one or more of:
virtual machine type;
virtual machine size; and
virtual machine configuration.

18. The computer program product according to claim 15, wherein the hardware information concerning one or more nodes hosting the plurality of virtual machines includes one or more of:
an indication of a failure of at least one hardware component; and
a state of at least one hardware component.

19. The computer program product according to claim 18, wherein the at least one hardware component includes one or more of a processor, a memory, a storage device, a field programmable gate array (FPGA), a network interface card (NIC), a system-on-chip (SOC), a power supply, a PCIe component, and a graphics processor.

20. The computer program product according to claim 16, wherein generating the correlation between interruptions of at least a subset of the plurality of virtual machines and one or more hardware component attributes includes identifying a correlation between a virtual machine interruption and a specific hardware component failure.
